(19) United States
(12) Patent Application Publication
(10) Pub. No.: US 2004/0251313 A1
(43) Pub. Date: Dec. 16, 2004

(54) ATV crop sprayer

(76) Inventor: James T. Burgess, Angwin, CA (US)

Correspondence Address: HOWARD COHEN, 1105 THE ALAMEDA, BERKELEY, CA, 94707, US

(21) Appl. No.: 10/854,001

(22) Filed: May 26, 2004

Related U.S. Application Data
(60) Provisional application No. 60/477,630, filed on Jun. 11, 2003.

(51) Int. Cl. B05B 9/06

(52) U.S. Cl. 239/100

(57) ABSTRACT

A crop spraying apparatus includes a self-powered blower mounted on the rear rack of an ATV, with an air manifold extending behind the blower. Left and right spray nozzle assemblies are mounted on respective branches of the manifold, each actuatable either individually or together, so that the spray pattern may be directed to either side or both sides of the ATV. A tank is mounted on the front of the ATV, and a pump delivers pressurized liquid from the tank to a pair of isolation valves at the rear of the ATV. From the valves the solution is fed to injectors, each injector secured in one of the spray nozzles. The blast of air exiting each nozzle breaks up the injected solution into a fine mist that is carried by the air stream to the crops.

### CROSS-REFERENCE TO RELATED APPLICATIONS

This application claims the priority date of Provisional Patent Application 60/477,630, filed Jun. 11, 2003.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to crop sprayers and, more particularly, to sprayers that are capable of operating in constricted spaces found in some orchards and vineyards.

2. Description of Related Art

Crop spraying apparatus typically consists of self-powered trailer rigs towed behind an ATV vehicle, or trailer rigs that are towed behind a tractor and derive their power from the power takeoff of the tractor. Other such devices are mounted to the typical three-point hitch of a farm tractor and also receive mechanical power from the power takeoff of the tractor. For extremely confined spaces, there are backpack models that incorporate a small tank, engine, and spray nozzle secured to a hose coupled to the pump driven by the engine.

Towed spray rigs may be difficult to maneuver in the confined spaces of a vineyard or orchard, and are always difficult to back up in such confined spaces. The power takeoff connection to a tractor can cause steering and maintenance problems, and requires time and effort to set up and remove. Backpack models are necessarily limited in tank capacity, engine power (and thus spray volume and velocity, and are onerous for the worker carrying the rig. Thus the prior art reveals a deficiency in the crop spraying rigs that are presently available, particularly for use in the sometimes narrow spaces of vineyards and orchards, where lateral growth of the crop plants may restrict the path openings through the rows.

### BRIEF SUMMARY OF THE INVENTION

The present invention generally comprises a crop spraying apparatus that is small, powerful, maneuverable, and cost-effective for treating crops such as vineyards and orchards. A salient aspect of the invention is that it is built on the platform of a commercially available ATV, and that it makes use of commercially available components.

The spraying rig includes a self-powered blower mounted on the rear rack of the ATV, with an air manifold extending behind the blower. The manifold divides into left and right branches, and left and right spray nozzle assemblies are mounted on respective branches of the manifold. The spray nozzle assemblies include a plurality of nozzles aimed laterally outwardly and upwardly from the rear of the ATV. Each spray nozzle assembly is actuatable either individually or together, so that the spray pattern may be selected to extend from either side or both sides of the ATV as it is driven alongside a crop row or between adjacent crop rows.

A reservoir tank is mounted on the front of the ATV, and a manifold and filter combination feeds a pair of pumps; one pump recirculates the liquid to maintain a uniform solution, the other (supply pump) delivers pressurized liquid from the tank through a flexible hose to a pair of isolation valves at the rear of the ATV that are individually controlled by operator switches. A pressure control bypass valve is interposed between the supply pump and the isolation valves to enable the operator to adjust the pressure supplied to the valves. From the valves the solution is fed to left and right headers, and thence to a plurality of injectors, each injector secured in one of the spray nozzles. The blast of air exiting each nozzle breaks up the injected solution into a fine mist that is carried by the air stream to the crops. The isolation valves permit the operator to select left, right, or left and right spray patterns in accordance with the position of the ATV as it is driven between crop rows or adjacent to a single crop row. A metering valve interposed between each header and its isolation valve enables the operator to control the flow rate of the solution into the spray assemblies.

### BRIEF DESCRIPTION OF THE DRAWING

FIG. 1 is a side elevation of the ATV crop sprayer of the present invention.

FIG. 2 is a rear view of the ATV crop sprayer shown in FIG. 1.

FIG. 3 is a front view of the ATV crop sprayer shown in FIGS. 1 and 2.

FIG. 4 is a rearward view of the ATV crop sprayer of FIGS. 1 and 2, taken from the driver's seat of the vehicle.

FIG. 5 is a detailed perspective view of the reservoir tank and recirculation pump of the ATV crop sprayer of the invention.

### DETAILED DESCRIPTION OF THE INVENTION

The present invention generally comprises a small, mobile, yet powerful crop spraying apparatus that is particularly adapted for use in narrow aisles and pathways between crops such as grapes and fruit trees.

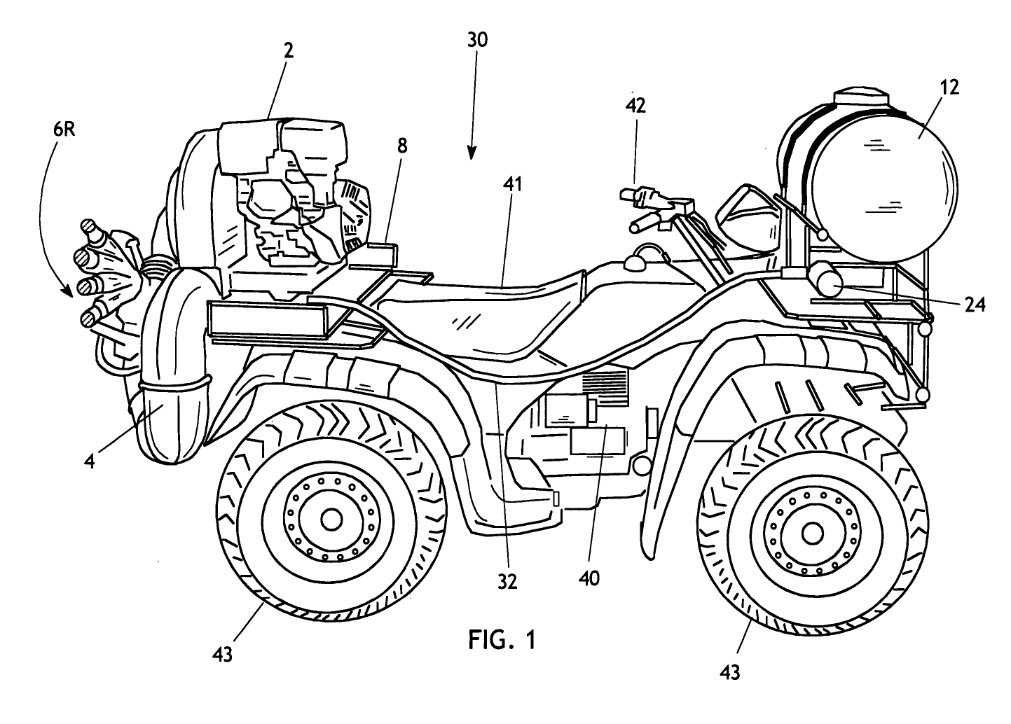

The invention takes advantage of the commercial availability of All Terrain Vehicles (hereinafter, ATV), which are well known in the art. Generally, an ATV comprises (FIG. 1) a small four wheel drive vehicle 30 having a centrally mounted saddle seat for the driver, an internal combustion engine 40 below the saddle 41 (in the manner of a motorcycle), a handlebar 42 connected to steerable front wheels, and large all terrain tires 43 for use in off-road and back country settings. ATVs are sold in sport versions for off road uses such as camping, hunting, fishing, and exploring; and utility versions that provide front and rear racks for carrying tools, supplies, farm implements and the like. ATVs have a wide wheelbase for exceptional lateral stability, yet are extremely maneuverable in confined spaces.

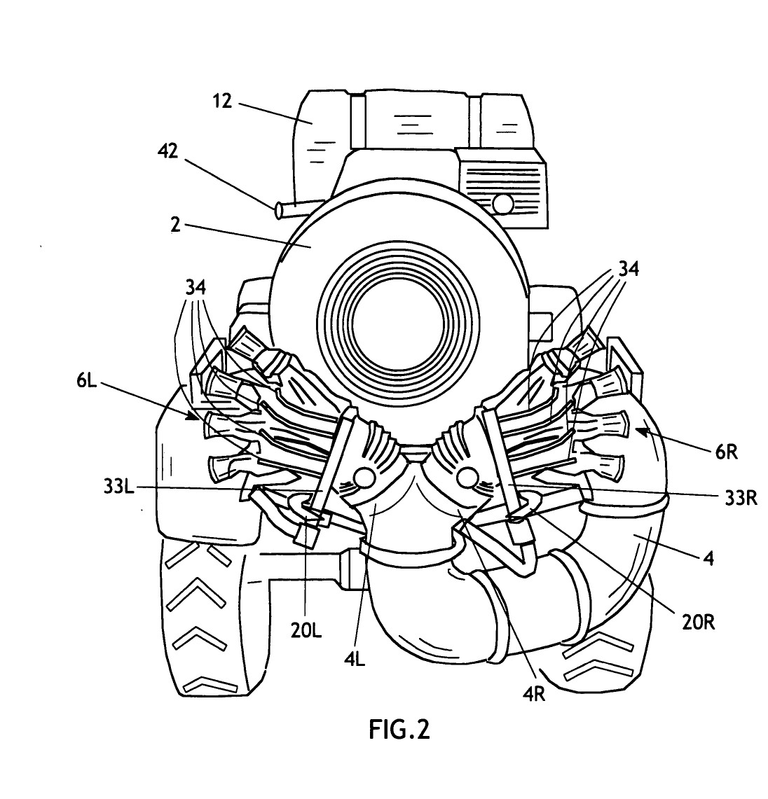

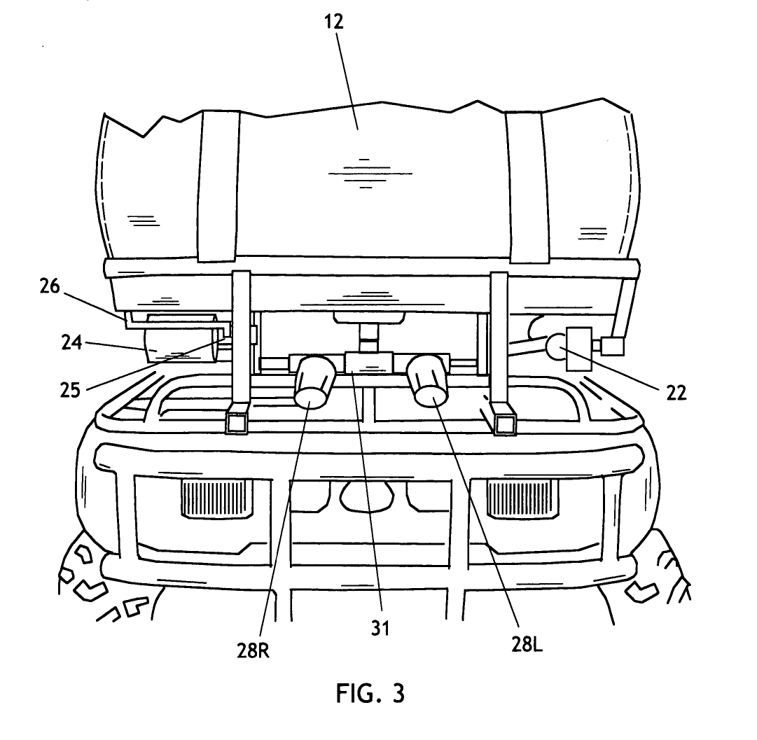

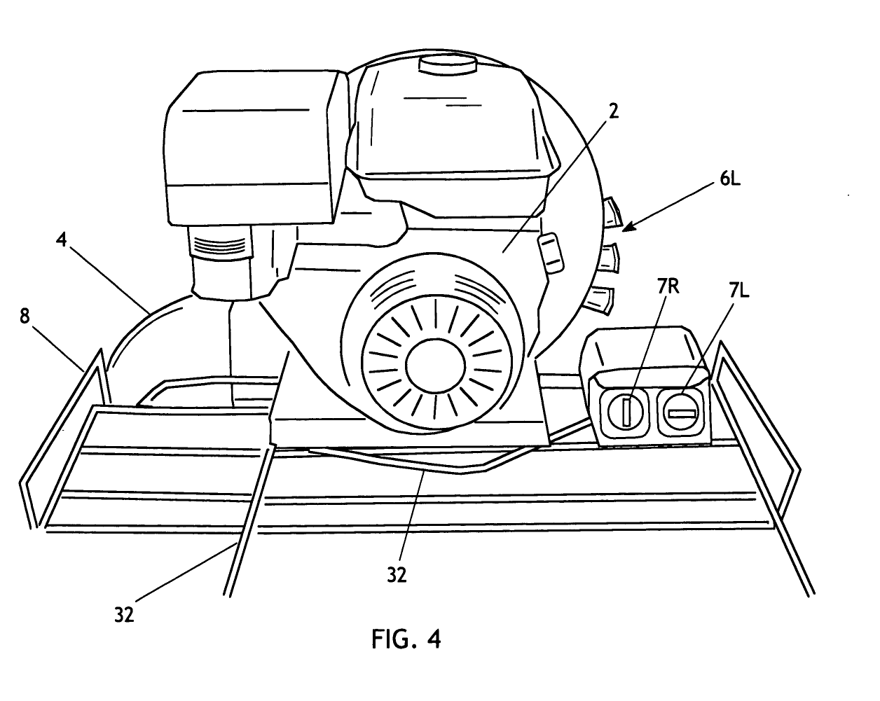

With regard to FIGS. 1-5, the invention provides a self-powered blower 2 mounted on a rack 8 on the rear of the ATV 30. An air manifold 4 extends from the side discharge of the blower 2 through an arc of approximately 180° to the rear of the ATV. The manifold bifurcates into left and right portions 4L and 4R that extend obliquely upwardly at the rear of the ATV 30. Each manifold portion 4L and 4R is connected to a respective spray nozzle assembly 6L and 6R, each assembly having four nozzles that are disposed in a vertical stack and are aimed laterally outwardly and upwardly from the ATV 30. Each spray nozzle assembly is actuatable either individually or together, so that the spray pattern may be selected to extend from either side or both sides of the ATV as it is driven alongside a crop row or between adjacent crop rows.

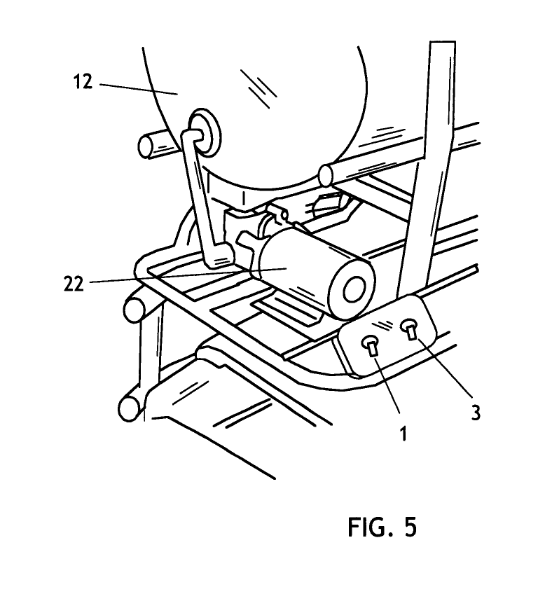

At the front of the ATV 30, a reservoir tank 12 is mounted on a rack that extends over the front hood and fenders of the vehicle. The tank is designed to hold liquid to be sprayed by the nozzle assemblies 6, such as insecticide, fungicide, herbicide, fertilizer, or the like. The tank 12 gravitally feeds a supply manifold 31 which extends laterally and leads to left and right filters 28L and 28R. Filter 28L is connected to a recirculation pump 22 that outputs back into the tank 12 to maintain the liquid well mixed. Filter 28R is connected to supply pump 24, which delivers its pressurized output through flexible hose 32 to a pair of isolation valves 7L and 7R located behind the saddle of the ATV 30. A pressure control valve 25 is interposed between the output of pump 24 and the flexible hose 32 to enable the operator to control the pressure delivered through the hose. The valve 25 includes a bypass 26 that feeds excess liquid back into the tank 12. Each valve is controlled manually, so that flow to either or both sides may be selected easily. Pumps 22 and 24 are controlled by toggle switches 1 and 3 located adjacent to the pump 22 at the front of the ATV, as shown in FIG. 5.

Each valve 7L and 7R is connected through a flexible tube to a respective header 33L and 33R at the rear of the ATV adjacent to the spray nozzle assemblies. Extending from each header 33L and 33R are a plurality of supply hoses 34, each leading to an injector disposed in a respective one of the spray nozzles. Interposed between the valves 7 and the headers 33 are calibration disk assembly 20L and 20R, which are provided to control the rate of liquid flow to the headers. Thus the rig operator may select the amount of liquid being sprayed out through the nozzles 6.

To use the ATV crop sprayer of the present invention, the operator first starts the ATV engine, and starts the blower 2 to provide a large flow of air to the spray nozzle assemblies 6L and 6R. In the preferred embodiment the blower is a commercially available unit that includes its own internal combustion engine, fuel tank, and starter system. The operator then switches on toggle switches 1 and 3 to activate pumps 22 and 24. The spray solution is drawn through filters 28L and 28R by the pumps, so that pump 22 recirculates the solution and maintains its uniform mixture, and pump 24 delivers the solution under pressure to isolation valves 7L and 7R. The pressure is set by the operator using pressure control valve 25, which diverts some of the output of pump 24 back through bypass 26 into the tank 12. The manual controls of valves 7L and 7R are used to select the activation of one or both spray nozzle assemblies 6L or 6R. The solution under pressure is fed through headers 33L and 33R to the respective spray nozzle assemblies, where the solution is injected adjacent to the spray outlets. When the high velocity air hits the fluid being injected into the nozzle heads, the solution forms a fine mist that is carried by the air stream from each nozzle to the adjacent crops as the ATV is driven between or adjacent to the crop rows.

It may be appreciated that the toggle switches 1 and 3, as well as the valves 7L and 7R are easily accessed by the operator of the ATV 30, so that it is easy for the operator to switch the pumps on and off to start and stop spraying (as, for example, when driving to the next crop row to be treated), and to select a spray pattern to both sides or either side of the vehicle.

The crop spray rig of the invention may deliver a fairly exact amount of solution to the crops being treated. It has been empirically observed that the following relationship pertains:

(Gallons/minute)=(number of sides)×(mph)×(gallons per acre)×width of rows/1000

As an example, if it is intended to spray 25 gallons of solution per acre, in a vineyard having rows 6 feet wide, and the ATV will be driven at a velocity of 3 mph, and both sides of the row are being sprayed at the same time, the result is 0.9 gallons per minute. This calculation enables the operator to set the spray pressure at valve 25 and the calibration disks 20L and 20R to achieve an exact spray rate.

Of course, the operator of the ATV crop sprayer must be protected with clothing and respiration equipment appropriate for the solution being sprayed onto the crops.

A salient aspect of the ATV crop sprayer is that it employs, to the greatest extent possible, commercially available hardware, such as the ATV itself, the blower 2, as well as the pumps and valves. Thus the construction costs are minimized, so that the invention provides a crop sprayer that provides maximum performance in a very cost-effective apparatus. In addition, it may be appreciated that the weight of the spray rig is well-balanced on the ATV 30, with the reservoir tank 12 being supported at the front of the vehicle, and the blower and spray nozzle assemblies being supported at the rear.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A crop spraying apparatus, including:
a four wheel ATV;
a blower mounted on the rear of the ATV and connected to deliver high velocity airflow to an air manifold disposed rearwardly of the blower;
a pair of spray nozzle assemblies secured to the output of said manifold, said spray nozzle assemblies emitting said high velocity airflow and forming spray patterns that are directed laterally outwardly from the rear of said ATV;
a reservoir tank supported on the front of said ATV for storing a solution to be sprayed;
first pump means connected to said tank and adapted to receive said solution;
fluid injector means connected to the output of said first pump means for injecting said solution into said pair of spray nozzle assemblies, whereby said high velocity airflow transforms the injected solution into a fine mist sprayed from said nozzle assemblies.

2. The crop spraying apparatus of claim 1, wherein each of said pair of spray nozzle assemblies includes a plurality of spray nozzles.

3. The crop spraying apparatus of claim 2, wherein said fluid injector means includes a plurality of fluid injectors, each fluid injector coupled to one of said spray nozzles.

4. The crop spraying apparatus of claim 1, further including second pump means connected to said tank and adapted to receive said solution and recirculate said solution back into said tank.

5. The crop spraying apparatus of claim 4, wherein said first and second pump means are connected to a common fluid supply manifold extending from said tank.

6. The crop spraying apparatus of claim 5, wherein said first and second pump means are mounted on a front portion of said ATV.

7. The crop spraying apparatus of claim 3, wherein said pair of spray nozzle assemblies comprise left and right assemblies, and further including left and right isolation valves interposed between said first pump means and said fluid injectors to selectively actuate either or both of said left and right assemblies.

8. The crop spraying apparatus of claim 7, further including metering means interposed between said left and right isolation valves for controlling the flow rate of said solution to said plurality of fluid injectors.

9. The crop spraying apparatus of claim 1, wherein said blower includes a self-powering internal combustion engine.

10. The crop spraying apparatus of claim 1, wherein said air manifold extends from the output of said blower to said pair of spray nozzle assemblies in an arc of approximately 180°.

11. The crop spraying apparatus of claim 10, wherein said air manifold has an outlet end that is bifurcated to left and right outputs, each connected to one of said pair of spray nozzle assemblies.

12. The crop spraying apparatus of claim 11, wherein each of said pair of spray nozzle assemblies includes four spray nozzles arrayed in a common, substantially vertical plane.

13. The crop spraying apparatus of claim 1, further including a pressure control valve interposed between said first pump means and said fluid injector means.

14. The crop spraying apparatus of claim 13, wherein said pressure control valve includes a selectively controlled bypass that returns solution to said reservoir tank.
